(19) United States
(12) Patent Application Publication
(10) Pub. No.: US 2007/0250725 A1
(43) Pub. Date: Oct. 25, 2007

(54) Power Saving Device for an Actuator

(76) Inventors: Pang-Chiang Chia, Taichung (TW); Ming-Hsing Chi, Taichung (TW)

Correspondence Address: BANGER SHIA, 204 CANYON CREEK, VICTORIA, TX, 77901, US

(21) Appl. No.: 11/379,570

(22) Filed: Apr. 20, 2006

(51) Int. Cl. G06F 1/32

(52) U.S. Cl. 713/320

(57) ABSTRACT

A power saving device for an actuator comprises a portable power source, a charging circuit, a control circuit, a starting circuit for starting the power source, a microprocessor, and a switch. When the equipment is not in use, the power source will be cut off, and the power consumption will be zero, if the self-discharge of the portable power source is not taken into account.

### BACKGROUND OF THE INVENTION

1. Field of the Invention

The present invention relates to a power saving device, and more particularly to a power saving device for an actuator using portable power source, when the equipment is not in use, the power source will be cut off, and the power consumption will be zero, if the self-discharge of the portable power source is not taken into account.

2. Description of the Prior Art

As shown in FIG. 1, a conventional portable power source is essentially comprised of power source circuit, switch circuit, charging circuit, and control circuit. This power source is generally used in the following three ways:

A, the user has to manually turn on the switch circuit, then the power source circuit is switched on and starts supplying energy to the control circuit. When the power source energy is short of energy, the charging circuit will charge it.

B, the switch circuit is on all the time, the user doesn't need to manually turn on the switch circuit, and the energy circuit keeps supplying energy all the time to the control circuit. When the power source energy is short of energy, the charging circuit will charge it. When the equipment is not in use, the control circuit goes into standby mode, and power consumption is reduced. However, standby mode still consumes a small amount of energy.

C, the switch circuit is on all the time, the user doesn't need to manually turn on the switch circuit, and the energy circuit keeps supplying energy all the time to the control circuit. When the power source energy is short of energy, the charging circuit will charge it. This design doesn't have power saving function, and the equipment still consumes a lot of power when not in use.

Hence, the conventional power saving method is actually unable to produce more economic benefit.

To solve the aforementioned problems, the inventor of this invention, based on many years of experiences and skills in the actuator field, develops a brand new power saving device for an actuator.

### SUMMARY OF THE INVENTION

The primary objective of the present invention is to provide a power saving device for an actuator using portable power source, when the equipment is not in use, the power source will be cut off, and the power consumption will be zero, if the self-discharge of the portable power source is not taken into account.

A power saving device for an actuator in accordance with the present invention comprises a portable power source, a charging circuit, a control circuit, a starting circuit for starting the power source, a microprocessor, and a switch.

The present invention will be more clear from the following description when viewed together with the accompanying drawings, which show, for purpose of illustrations only, the preferred embodiment in accordance with the present invention.

### BRIEF DESCRIPTION OF THE DRAWINGS

FIG. 1 is a block diagram of showing a conventional equipment using portable power source;

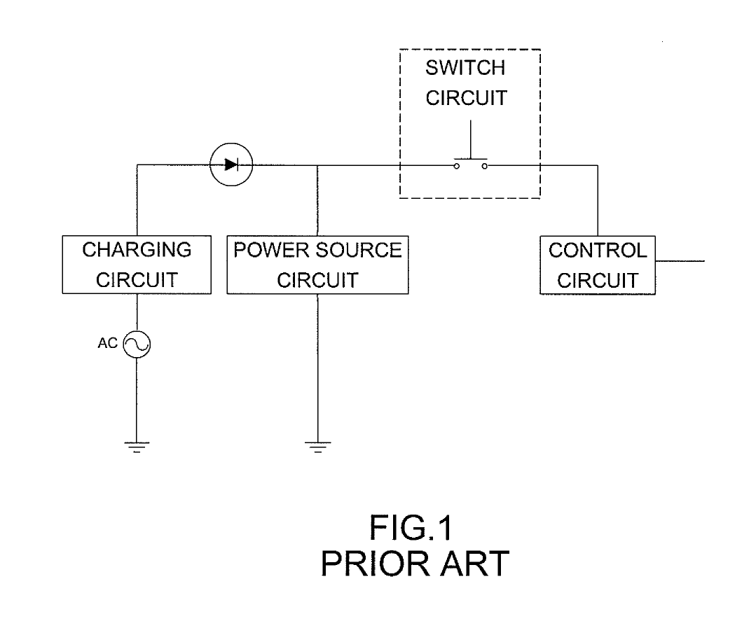

FIG. 2 is a block diagram of showing a power saving device for an actuator in accordance with the present invention; and

FIG. 3 is a circuit diagram of showing the power saving device for an actuator in accordance with the present invention.

### DETAILED DESCRIPTION OF THE PREFERRED EMBODIMENTS

The foregoing, and additional objects, features and advantages of the present invention will become apparent from the following detailed description of preferred embodiment thereof, taken in conjunction with the accompanying drawings.

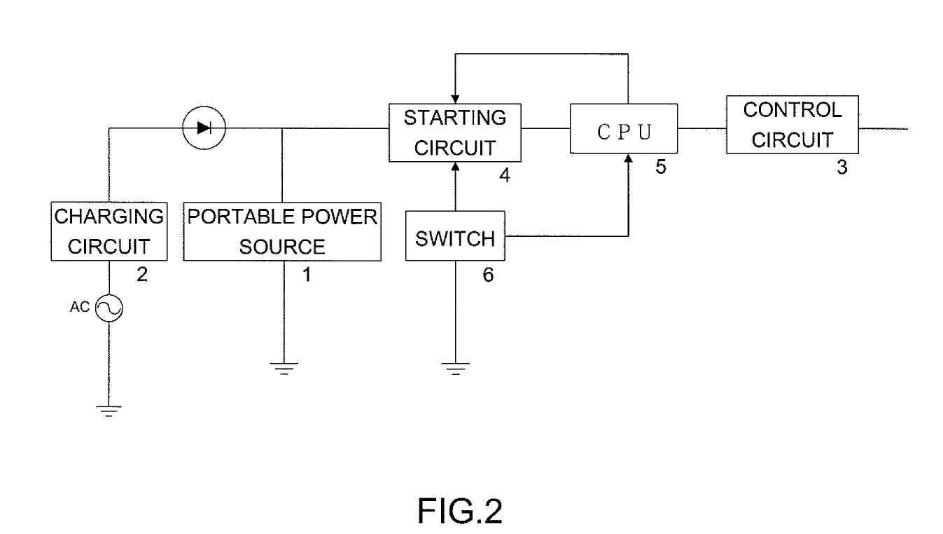

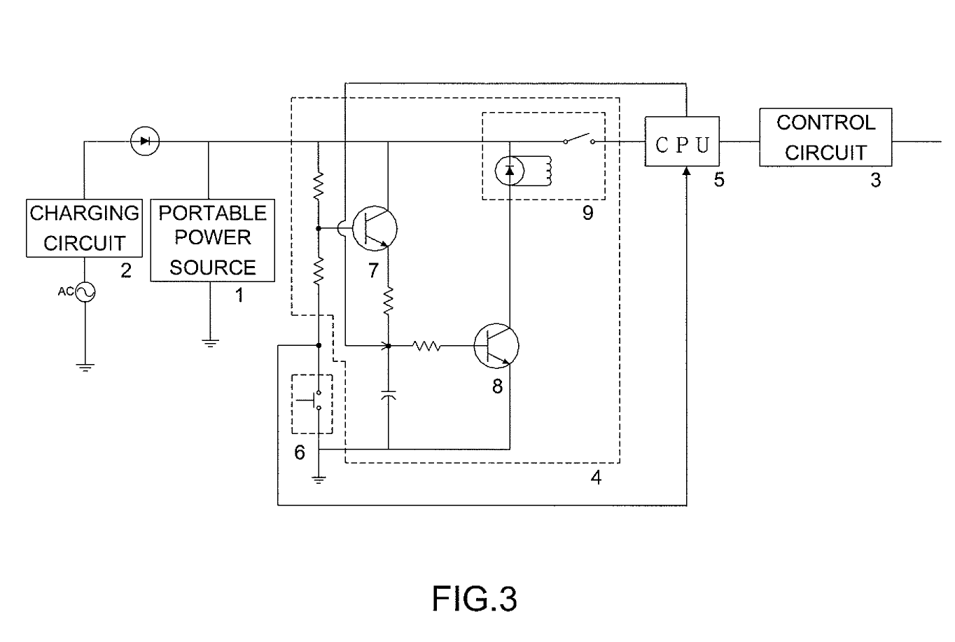

Referring firstly to FIGS. 2 and 3, a power saving device for an actuator comprises a portable power source 1 (which is a storage battery for example), a charging circuit 2, a control circuit 3, a starting circuit 4 for starting the power source, a microprocessor 5, and a switch 6.

The portable power source 1 (storage battery) serves as a power supply of a whole system.

The charging circuit 2 serves to charge the storage battery 1 and prevents overcharging of the storage battery 1.

The control circuit 3 has an operation control system serving to control the operation of equipment.

The starting circuit 4 serves to switch the connection between the storage battery 1 and the whole system.

The microprocessor circuit 5 provides a control instruction to the control circuit 3 and has a function of checking and starting the power-saving function.

The switch 6 is an ordinary switch and serves to actuate the starting circuit 4 and then to start the control circuit 3.

In operation, the storage battery 1, the charging circuit 2, and the starting circuit 5 are connected together, so that the charging circuit 2 still can charge the storage batter 1 even when the starting circuit 5 is not working.

In addition, the switch 6 is able to actuate the starting circuit 5 and the microprocessor circuit 4, respectively. Pressing the switch 6 can switch on the PNP transistor 7, after switching on the PNP transistor 7, the NPN transistor is switched on, and the Relay 9 is turned on. Once the Relay 9 is turned on, the starting circuit 5 will be started, and then the microprocessor circuit 4 starts operation.

When the microprocessor circuit 4 receives the signal from the switch 6 and sends corresponding signal to the control circuit 3, at the same time, the microprocessor circuit 4 intervenes the control operation of the starting circuit 5 to keep the Relay 9 on. At this moment, the NPN transistor 8 is still controlled by the microprocessor circuit 4 to keep the Relay 9 on, even if the switch 6 switches off the PNP transistor 7.

After releasing the switch 6, the starting circuit 5 is still on due to the interference of the microprocessor circuit 4. The microprocessor circuit 4 determines when to go into power saving mode, and then turns the NPN transistor 8 off. After the NPN transistor 8 is turned off, the Relay 9 will be turned off. At this moment, the microprocessor circuit 4 and the control circuit 3 will be disconnected from power source, and the power consumption is zero.

To summarize, the present invention has the following advantages:

It can actuate the control circuit simply by using an ordinary switch, after releasing the switch, the microprocessor circuit will take part in the management of power source and determine when to go into the power saving mode, so that the actuator can be used at a higher level. For example, the position memory of the actuator, the data collection of hospital bed, and so on, and it also has a power saving function. The power saving function is particularly important for equipment using portable power source.

It is to be noted that this is a pioneering work in the field of the equipment using portable power source, it not only provides environmental friendly products, but also improves the functionality and the added value of the products.

While we have shown and described various embodiments in accordance with the present invention, it is clear to those skilled in the art that further embodiments may be made without departing from the scope of the present invention.

What is claimed is:

1. A power saving device for an actuator comprising:
a portable power source serving as a power supply of a whole system;
a charging circuit for charging the portable power source and protecting the storage battery from overcharge;
a control circuit having an operation control system serving to control operation of equipment;
a starting circuit serving to switch connection between the portable power source and the whole system;
a microprocessor circuit serving to provide a control instruction to the control circuit and to check and start power-saving function; and
a switch serving to actuate the starting circuit and then to start the control circuit.

2. The power saving device for an actuator as claimed in claim 1, wherein the portable power source is a storage battery.

3. The power saving device for an actuator as claimed in claim 1, wherein the control circuit includes a set of Relay.

4. The power saving device for an actuator as claimed in claim 1, wherein the starting circuit is in the form of transistor, optical coupler, or Relay.
